(19) United States
(12) Patent Application Publication
(10) Pub. No.: US 2022/0397758 A1
(43) Pub. Date: Dec. 15, 2022

(54) OPTICAL DEVICE AND DISPLAY DEVICE

(71) Applicant: CANON KABUSHIKI KAISHA, Tokyo (JP)

(72) Inventors: Yoshihiko Konno, Tokyo (JP); Nobuyoshi Suzuki, Tokyo (JP); Kiyoshi Nitto, Saitama (JP); Hirohito Kai, Tokyo (JP); Manabu Sueoka, Kanagawa (JP)

(21) Appl. No.: 17/889,479

(22) Filed: Aug. 17, 2022

Related U.S. Application Data
(63) Continuation of application No. PCT/JP2021/011117, filed on Mar. 11, 2022.

(30) Foreign Application Priority Data
Mar. 19, 2021 (JP) 2021-045672

(51) Int. Cl. G02B 27/00

(52) U.S. Cl. CPC G02B 27/0018; G02B 27/0093; G02B 25/001

(57) ABSTRACT

A head-mounted display (HMD) having a line-of-sight detection function includes angle selection type transmission elements that are disposed in a finder optical path for eyes of a user, respectively, a light projecting unit and a light receiving unit for line-of-sight detection, and is configured to be capable of adjusting a direction of a finder to a detected line-of-sight direction. The angle selection type transmission elements have first to third opening portions with different directions. The first and second opening portions limit a passage direction of light in first and second regions in a finder optical path, respectively. The third opening portion is formed around a line connecting an eye point and the light receiving unit.

### CROSS-REFERENCE TO RELATED APPLICATIONS

This application is a Continuation of International Patent Application No. PCT/JP2022/011117, filed Mar. 11, 2022, which claims the benefit of Japanese Patent Application No. 2021-045672, filed Mar. 19, 2021, both of which are hereby incorporated by reference herein in their entirety.

### BACKGROUND OF THE INVENTION

### Field of the Invention

The present invention relates to a ghost reduction technology in a head-mounted display, binoculars, a camera finder, or the like, and particularly to an optical device and a display device that include an angle selection type transmission element.

### Background Art

When a user uses a head-mounted display or a camera finder outdoors, a ghost may occur due to light coming from behind the user. Patent Literature 1 discloses a technology for cutting light that causes a ghost by disposing a louver film on an eye side of a display unit.

In addition, a camera having a line-of-sight detection function that realizes a function of selecting a ranging point by detecting a line-of-sight direction of the user has been put into practical use (Patent Literature 2).

### CITATION LIST

### Patent Literature

Patent Literature 1: Japanese Patent Laid-Open No. H5-215908

Patent Literature 2: Japanese Patent No. 3186072

In conventional technologies, there are problems that vignetting occurs and an opening ratio decreases due to a narrow eye box. In addition, it is necessary to take measures against vignetting of light of an infrared light source (LED) directed from an eye point to a line-of-sight detection sensor.

### SUMMARY OF THE INVENTION

An object of the present invention is to suppress vignetting and a decrease in opening ratio and to enable eyepiece observation and line-of-sight detection while reducing ghosts caused by light from behind a user in an optical device that uses an angle selection type transmission element.

According to one embodiment of the present invention, an optical device including a finder includes an angle selection type transmission element that is disposed in an optical path of the finder, a detection unit configured to perform line-of-sight detection by light passing through the angle selection type transmission element, and a mechanical unit that is capable of adjusting a direction of the finder to a line-of-sight direction detected by the detection unit.

According to the present invention, in an optical device using an angle selection type transmission element, eyepiece observation and line-of-sight detection can be performed while suppressing vignetting and a decrease in opening ratio and reducing ghosts caused by light from behind a user.

Further features of the present invention will become apparent from the following description of exemplary embodiments with reference to the attached drawings.

### BRIEF DESCRIPTION OF THE DRAWINGS

FIG. 1 is an external view of a display device (a head-mounted display) to which the present invention is applied.

FIG. 2 is a view which displays a usage state in which a user has attached the display device to their head.

FIG. 3 is a view which shows a state in which a display unit is flipped upward from the state of FIG. 2.

FIG. 4 is a cross-sectional view which shows a configuration when the display device is used.

FIG. 5 is a cross-sectional view along line A-A of FIG. 2.

FIG. 6 is a cross-sectional view which represents a relationship between the head and an eyeball of the user and the display device.

FIG. 7 is a detailed view which shows a portion B of FIG. 6.

FIG. 8 is a view which shows a first surface side of an angle selection type transmission element.

FIG. 9 is a cross-sectional view along line C-C of FIG. 8.

FIG. 10 is an optical path view when a line of sight is detected.

FIG. 11 is a cross-sectional view which shows a configuration when a line of sight is detected.

FIG. 12 is a schematic view of an eyeball image when a line of sight is detected.

FIG. 13 is a view which shows a first surface side of an angle selection type transmission element according to a second embodiment.

FIG. 14 is a cross-sectional view along line D-D of FIG. 13.

### DESCRIPTION OF THE EMBODIMENTS

Hereinafter, embodiments of the present invention will be described in detail with reference to the drawings. A head-mounted display (hereinafter referred to as HMD) is shown as an example of a display device using an angle selection type transmission element disposed in an optical path such as a finder. The present invention can be applied not only to HMDs but also to various optical devices.

### First Embodiment

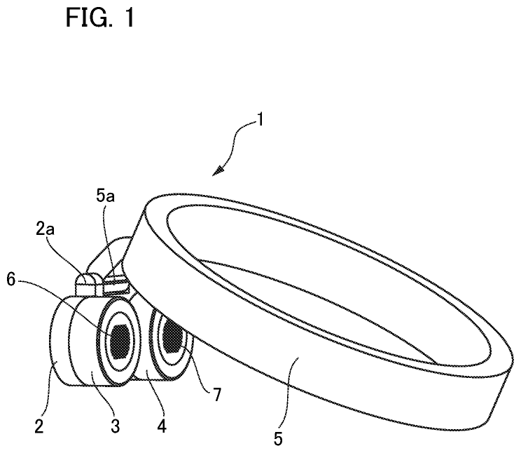

An electronic view finder (hereinafter referred to as an EVF) having a line-of-sight detection function according to the present embodiment will be described with reference to FIGS. 1 to 12. FIG. 1 is an external view which shows a configuration example of an HMD 1. The HMD 1 includes a main body 2, EVFs 3 and 4, and a head mounting portion 5. A paired EVF is composed of an EVF 3 for a left eye and an EVF 4 for a right eye, which correspond to both eyes of a user.

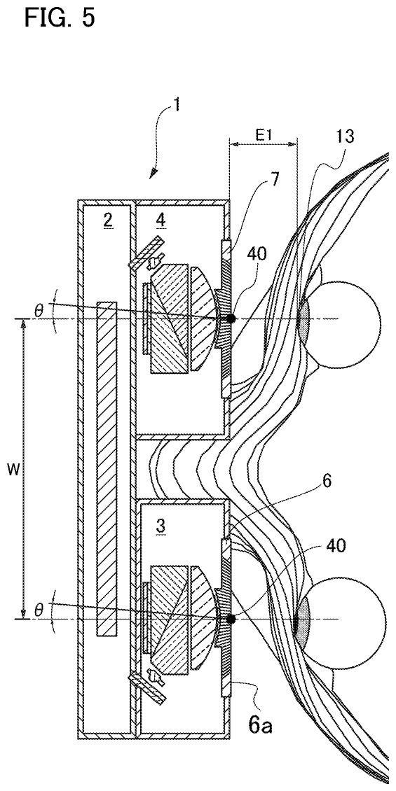

The main body 2 and the head mounting portion 5 of the HMD 1 can be rotated by a hinge 2a on the main body 2 side and a hinge 5a on the head mounting portion 5 side, and are coupled in a state in which an interval between the main body 2 and the eyes of the user (FIG. 5: a distance E1 between an eye point 13 and a surface 6a on the eye side) can be adjusted. The EVF 3 for the left eye and the EVF 4 for the right eye are held in a state in which an eye width can be adjusted with respect to the main body 2.

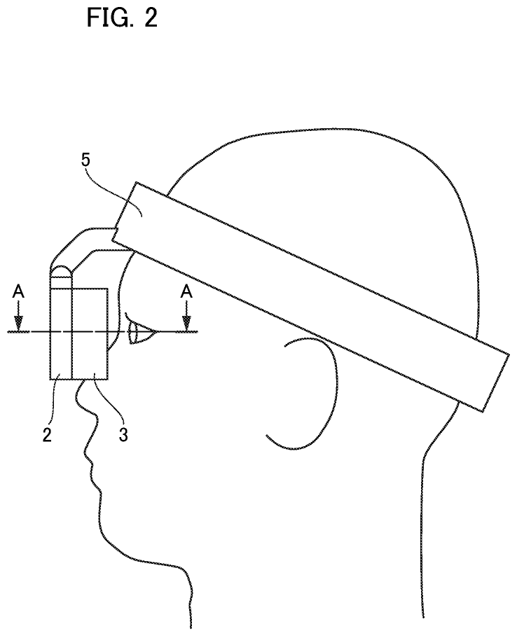

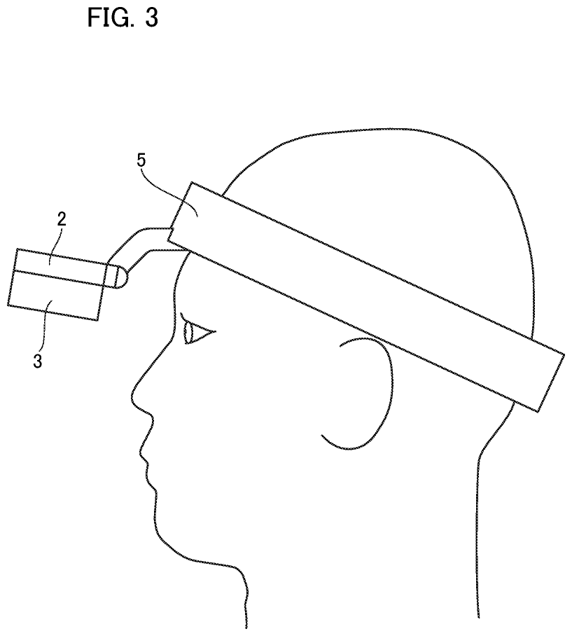

FIGS. 2 and 3 show a state in which the user has attached the HMD 1 to their head. FIG. 2 shows a state in which the user is looking at a display screen, and FIG. 3 shows a state in which the main body 2 of the HMD 1 is flipped upward so that the user can visually recognize their surroundings.

Angle selection type transmission elements 6 and 7 are attached to portions where the user looks into the EVF 3 and the EVF 4, respectively. Although the angle selection type transmission element 6 and the angle selection type transmission element 7 of the present embodiment have the same configuration, a convergence angle and ghost cut characteristics between the right eye and the left eye can be optimized by making the configurations of the elements different. In the following description, in the angle selection type transmission elements 6 and 7, an optical axis side of the finder is defined as the inside, and a side far from the optical axis of the finder is defined as the outside.

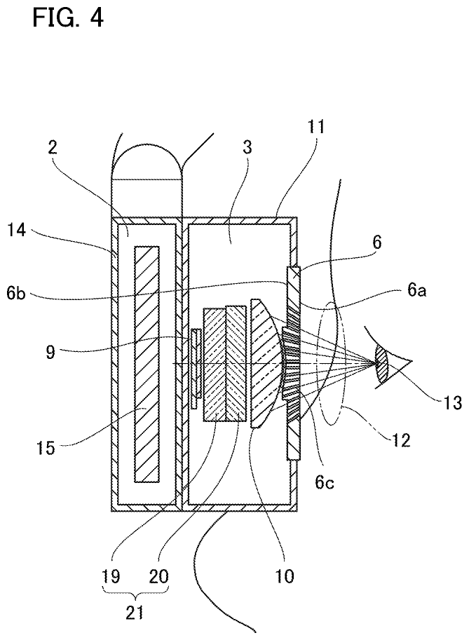

FIG. 4 is a cross-sectional view which shows the configurations of the main body 2 and the EVF 3 in a state in which the HMD 1 is used, and shows a portion corresponding to the left eye of the user. A display unit 9 and an eyepiece lens system 10 are provided inside an exterior member 11 of the EVF 3. The display unit 9 has an organic electro-luminescence (EL) display panel. The eyepiece lens system 10 has a surface on the angle selection type transmission element 6 side, which is a curved surface. The angle selection type transmission element 6 is disposed at a position facing the left eye of the user on the exterior member 11. In the angle selection type transmission element 6, a first surface 6a is a surface on the eye side of the user, and a second surface 6b is a surface on the eyepiece lens system 10 side. Details of an optical path split prism unit 21 disposed between the display unit 9 and the eyepiece lens system 10 will be described below.

The angle selection type transmission element 6 is provided with a plurality of opening portions 6c and has a function of limiting a light passage direction. The plurality of opening portions 6c are open in a direction of a light flux directed from the eyepiece lens system 10 to the eye point 13 which is a position of the eyes of the user. FIG. 4 schematically shows a finder luminous flux 12 that reaches the eye point 13 among light fluxes emitted from the eyepiece lens system 10. The eye point 13 is determined by the eyepiece lens system 10.

Inside an exterior member 14 of the main body 2 is a control circuit 15 that controls an entirety of the HMD 1. The control circuit 15 controls the display unit 9, and light from the display unit 9 is collected by the eyepiece lens system 10 and passes through the plurality of opening portions 6c provided in the angle selection type transmission element 6 to the eye point 13 to allow displayed information of the display unit 9 to be observed with an eye at the eye point 13.

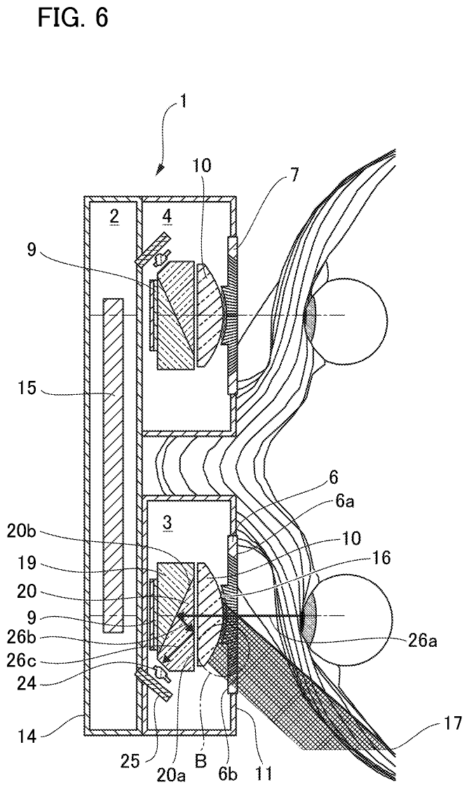

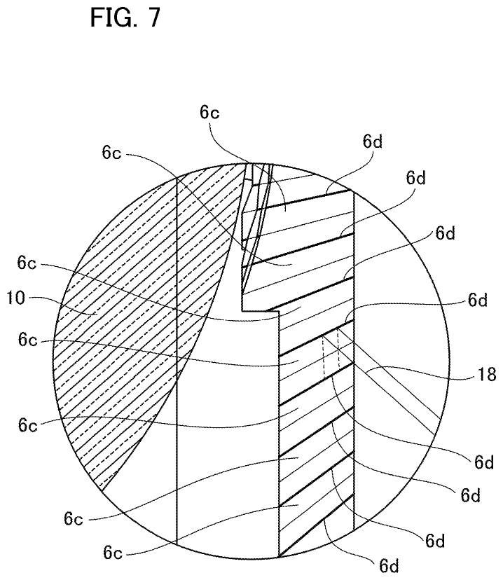

FIG. 5 is a cross-sectional view along line A-A of FIG. 2, and represents a relationship between the EVF 3 and EVF 4 and the head and eyeball when the HMD 1 is used. FIG. 6 represents a relationship between the head and eyeball and the HMD 1 when the HMD 1 is used. FIG. 7 is a detailed view of a portion B shown in FIG. 6.

FIG. 5 represents portions that can be adjusted using a relationship between the EVF 3 and EVF 4 and an eyeball. Since the user can visually recognize a display only from a vicinity of an eye point position, it is necessary to always maintain the position of the eyes in the vicinity of the eye point position. For this reason, the HMD 1 has first to third mechanism units whose positions can be adjusted by detecting the line-of-sight direction of the user and using a result of the line-of-sight detection.

A first mechanical unit has a configuration in which adjustment of adjusting an eye width (W) according to a width of both eyes of the user is possible. As a specific configuration, the EVFs 3 and 4 are guided by a guide bar or the like with respect to the main body 2, and each operates independently. A second mechanical unit has a configuration in which a distance (E1) between the eye point 13 and the surface 6a on the eye side of the angle selection type transmission element 6 (7) can be adjusted. A third mechanical unit has a configuration in which an angle (θ) in a rotation direction can be adjusted so that there is no change in vignetting or an opening ratio due to an eyeball rotation movement such as shaking a line of sight or changing the convergence angle. The EVF 3 (EVF 4) has a configuration capable of detecting the line-of-sight direction of the user and adjusting it in the rotation direction (a θ direction) around a region 40 where the surface 6a on the eye side and an optical axis of the eyepiece lens system 10 intersect with each other. As a specific configuration, the EVF 3 (EVF 4) constitutes a unit of the HMD 1 that can be adjusted in the rotation direction around the region 40. The unit of the HMD 1 is attached so that the eye width (W) can be adjusted with respect to the main body 2. Since each of the EVF 3 and EVF 4 has a mechanism capable of independent movement, the HMD 1 has a structure in which the EVF 3 and EVF 4 can be adjusted to optimum positions of left and right eyes by line-of-sight detection units disposed for each of the left and right eyes of the user. That is, a control unit of the HMD 1 performs control of calculating the positions of both eyes of the user according to the line-of-sight detection, and adjusting both positions to the optimum positions by calculating differences thereof with reference positions to match the EVF 3 and EVF 4 with respect to the positions of the left and right eyes.

By combining the line-of-sight detection function and the angle selection type transmission element, it is possible to solve the problems of vignetting and a decrease in opening ratio due to a narrow eye box. In addition, for parts that can be adjusted by the first to third mechanical units, there are two configurations: a configuration in which the user manually moves them using a lever or the like and a configuration in which a power source such as a motor, or the like is incorporated and they move automatically. The adjustment of the parts can be implemented in either configuration.

When the HMD 1 shown in FIG. 6 is used, complete forward light, that is, light coming from a direction in which the user turns their back to a light source (the sun or the like), is supposed. In this case, most of the light that backflows into the angle selection type transmission element 6 and the eyepiece lens system 10 is blocked by the head of the user. However, when the user rotates their face sideways at an angle of several tens of degrees from this state, light passing through a side surface of the face (light passing through a cross-hatched portion in FIG. 6) reaches positions of the angle selection type transmission element 6 and the eyepiece lens system 10.

In the case of the left eye, a region where back light is likely to generate a ghost in the eyepiece lens system 10 is the cross-hatched portion as shown by a line 17 connecting a point 16 in FIG. 6 and a side surface portion of the head. In the present embodiment, a plurality of opening portions 6c are provided from the eye point 13 to the eyepiece lens system 10. In order for light to reach the eyepiece lens system 10 positioned on a side farther from the user than the plurality of opening portions 6c, a light source needs to be present in directions of holes in the opening portions 6c. The line 17 in FIG. 6 shows a position where directions of the plurality of opening portions 6c and a direction of rays are closest to each other and the back light easily reaches the eyepiece lens system 10.

As shown in FIG. 7, the plurality of opening portions 6c inside the angle selection type transmission element 6 are partitioned between adjacent holes by a wall portion 6d. In the present embodiment, the plurality of opening portions 6c are filled with a transparent solid having a small difference in refractive index from air. By filling the inside of the angle selection type transmission element 6 with the transparent solid having a small difference in refractive index from air, it is possible to prevent dust from entering the plurality of opening portions 6c. In addition, it is possible to prevent the wall portion 6d from being deformed by an external force. In the present embodiment, a porous transparent substance containing air at 90% or more is used as the transparent solid having a small difference in refractive index from air, and the difference in refractive index from air is 0.1 or less. For this reason, there is almost no reflection at an interface with air. In the plurality of opening portions 6c, there is almost no reflection on a transparent solid surface having a small difference in refractive index from air on either the first surface 6a on the eye side or the second surface 6b on the eyepiece lens system 10 side. Light incident on the plurality of opening portions 6c from the outside is incident on the inside with almost no reflection.

Anti-reflection processing is performed on the second surface 6b on the eyepiece lens system 10 side, the first surface 6a on the eye side, and the wall portion 6d in the plurality of opening portions 6c in the angle selection type transmission element 6. The angle selection type transmission element can be created with a 3D printer, and the anti-reflection processing can be realized by anti-reflection coating.

In FIG. 7, a ray 18 represents light that has passed through a side surface of the head of the user. The ray 18 enters the inside from holes of the plurality of opening portions 6cprovided on the first surface 6a of the angle selection type transmission element 6. Light that has entered the inside of the plurality of opening portions 6c reaches the wall portion 6d, but reflected light is attenuated because the anti-reflection processing is performed on the wall portion 6d. Therefore, even if the reflected light reaches the eyepiece lens system 10, almost no ghost is generated.

A thickness of the angle selection type transmission element 6 is expressed as t, an opening width of the opening portion 6c is expressed as w, and an incident angle of unnecessary light is expressed as θ₀. Conditions for the unnecessary light not to reach the eyepiece lens system 10 directly are shown in the following Expression (1).

t≥w/tanθ₀ (1)

tan represents a tangent function, and a condition of Expression (1) is satisfied in the present embodiment.

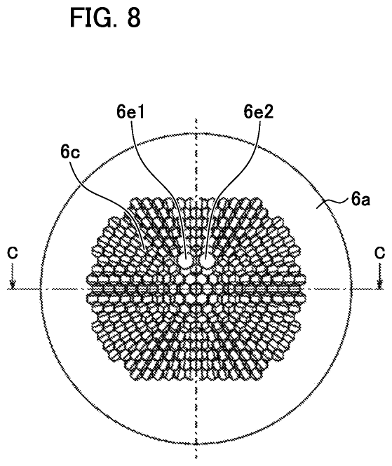

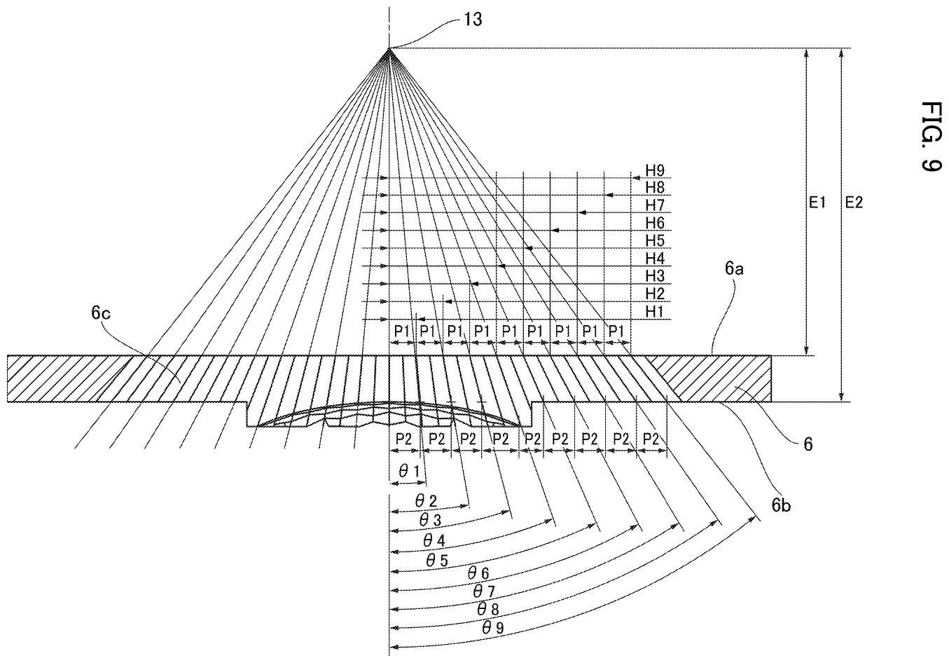

FIG. 8 is a view which schematically shows the first surface 6a of the angle selection type transmission element 6. The angle selection type transmission element 6 has opening portions 6e1 and 6e2 on the inner side and a plurality of opening portions 6c around them. FIG. 9 is a C-C cross-sectional view of FIG. 8. The plurality of opening portions 6c provided in the angle selection type transmission element 6 are formed in a hexagonal shape on the second surface 6b which is on an entrance side of a finder ray and the first surface 6a which is on an exit side of the finder ray. In addition, the adjacent hexagonal portions are partitioned by the wall portion 6d, and the insides are filled with a transparent solid having a small difference in refractive index from air.

FIG. 9 (a C-C cross-sectional view of FIG. 8) shows the directions of the plurality of opening portions 6c. The directions of the plurality of opening portions 6c are set to be along a direction of light directed to the eye point 13. A distance between the eye point 13 and the first surface 6a is expressed as E1, and a distance between the eye point 13 and the second surface 6b is expressed as E2. A formation pitch of the plurality of opening portions 6c on the first surface 6a is expressed as P1.

The plurality of opening portions 6c are provided at an equal pitch, and a distance from a center of the optical axis is expressed as Hi. In a right half surface of FIG. 9 with the center of the optical axis as a reference, i in “Hi” represents an arbitrary natural number from 1 to 9.

$$H 1 = P 1$$

$$H 2 = P 1 \times 2$$

$$…$$

$$H 8 = P 1 \times 8$$

$$H 9 = P 1 \times 9$$

That is, the relationship is “Hi=P1×i.”

An angle of each straight line connecting the eye point 13 and the plurality of opening portions 6c with the center of the optical axis as a reference is expressed as θi. i in “θi” represents an arbitrary natural number from 1 to 9.

$$θ 1 = {tan}^{- 1} ( H 1 / E 1 )$$

$$θ2 = {tan}^{- 1} ( H 2 / E 1 )$$

$$…$$

$$θ8 = {tan}^{- 1} ( H 8 / E 1 )$$

$$θ9 = {tan}^{- 1} ( H 9 / E 1 )$$

tan⁻¹ represents an inverse tangent function and has a relationship of “θi=tan⁻¹(Hi/E1).”

A pitch P2 of the plurality of opening portions 6c on the second surface 6b is as shown in the following Expression (2).

P2=E2×tanθ1 (2)

In FIG. 9, the right half surface with the center of the optical axis as a reference has been described, but, since the configuration is symmetrical with respect to the optical axis, the same relationship as described above is established for a left half surface.

If the eyepiece lens system 10 is seen from the eyes of the user with the eye point 13 as a reference, the eyepiece lens system 10 can be seen through the plurality of opening portions 6c. Since the wall portion 6d is substantially parallel to a direction of light reaching the eyes of the user, it can hardly be visually recognized. Moreover, if the eyes of the user are present at the eye point 13, the first surface 6a is close to the eyes and is visually out of focus. Since the wall portion 6d is made thin, a flat surface portion of an entrance portion of the wall portion 6d can hardly be visually recognized.

The user can visually recognize displayed information only from a vicinity of the eye point 13, and it is necessary to fix the positions of the eyes to the vicinity of the eye point 13. In the present embodiment, placement of the eyes on the eye point 13 is realized by fixing a relative positional relationship between the head of the user and the HMD 1 using the head mounting portion 5.

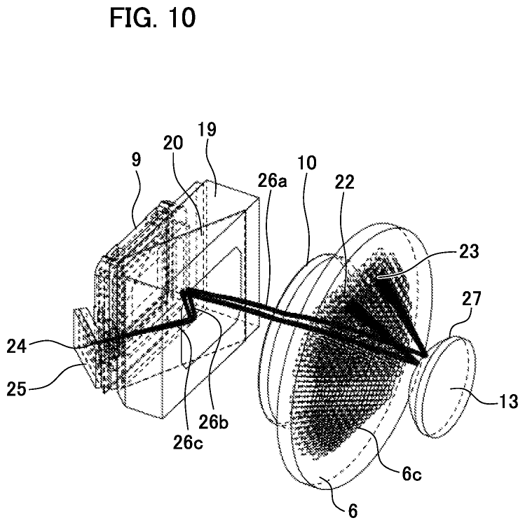

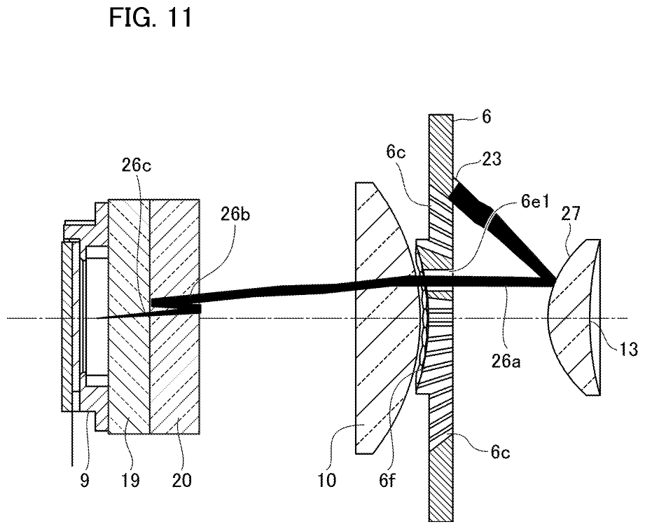

FIG. 10 is a perspective view which shows a configuration of an EVF portion. FIG. 11 is a cross-sectional view of the EVF portion on the optical axis. The angle selection type transmission element 6, the eyepiece lens system 10, a second optical path split prism 20, a first optical path split prism 19, and the display unit 9 are shown in order from the closest to the eye point 13.

The first optical path split prism 19 and the second optical path split prism 20 constitute an optical path split prism unit 21. The optical path split prism unit 21 is an optical path split means configured by adhering the first optical path split prism 19 and the second optical path split prism 20.

Infrared LEDs 22 and 23 are light emitting elements that perform eyeball illumination for line-of-sight detection. The infrared LEDs 22 and 23 constitute a light projecting unit and are disposed on the first surface 6a side of the angle selection type transmission element 6. The infrared LEDs 22 and 23 are disposed to emit infrared light toward different positions, and are used in pairs to detect a distance between an EVF portion (including a light receiving portion) and an eyeball of an observer. The lens 24 is a line-of-sight imaging lens of a line-of-sight detection optical system. The sensor 25 constituting the light receiving unit is a line-of-sight detection sensor.

Light from the eyeball illuminated by the infrared LEDs 22 and 23 passes through the angle selection type transmission element 6 and the eyepiece lens system 10 and is incident on the second optical path split prism 20 from the second surface 20a.

FIG. 6 shows this using an optical path 26a. A dichroic film that reflects infrared light is formed on the first surface 20b of the second optical path split prism 20.

The light from the eyeball illuminated by the infrared LEDs 22 and 23 is reflected by the first surface 20b of the second optical path split prism 20. The light is reflected in a direction of the second surface 20a. This reflected optical path is indicated using an optical path 26b. Light along the reflected optical path 26b is totally reflected by the second surface 20a, and light along an imaging optical path 26c is imaged on the line-of-sight detection sensor 25 by the line-of-sight imaging lens 24.

For the line-of-sight detection, a corneal reflex image formed by specular reflection of infrared LED light by cornea is used in addition to an eyeball image by illumination. FIG. 10 shows an optical path in which light emitted from the infrared LEDs 22 and 23 is reflected by a cornea 27 of the eyeball.

FIG. 11 shows the optical paths 26a, 26b, and 26c in which the light is reflected by the cornea 27 and is directed to the line-of-sight detection sensor 25. Among these optical paths, a direction of the optical path 26a is not the same as the direction of the opening portion 6c set to the direction of the light directed from the eyepiece lens system 10 to the eye point 13. The opening portions 6e1 and 6e2 on the inner side (refer to FIG. 8) in the angle selection type transmission element 6 through which light along the optical path 26a passes are formed substantially parallel to the optical path 26a such that vignetting does not occur. In addition, since there is an individual difference (difference in curvature of the cornea) in light emission of the optical path 26a, the opening portions 6e1 and 6e2 are formed larger than the adjacent opening portion 6c. Light passing through a side surface of the head of the user can easily enter the inside of the opening portions by increasing openings of the opening portions 6e1 and 6e2, but light is reflected more times to be attenuated inside the opening portions 6e1 and 6e2 by increasing the thickness of the angle selection type transmission element 6. In the present embodiment, a thickness of a portion 6f of the angle selection type transmission element 6 is larger than that of the peripheral portion. That is, a thickness of the portion 6f of the angle selection type transmission element 6 is increased along a facing surface (a curved surface) of the eyepiece lens system 10, and the opening portions 6e1 and 6e2 are formed in this portion.

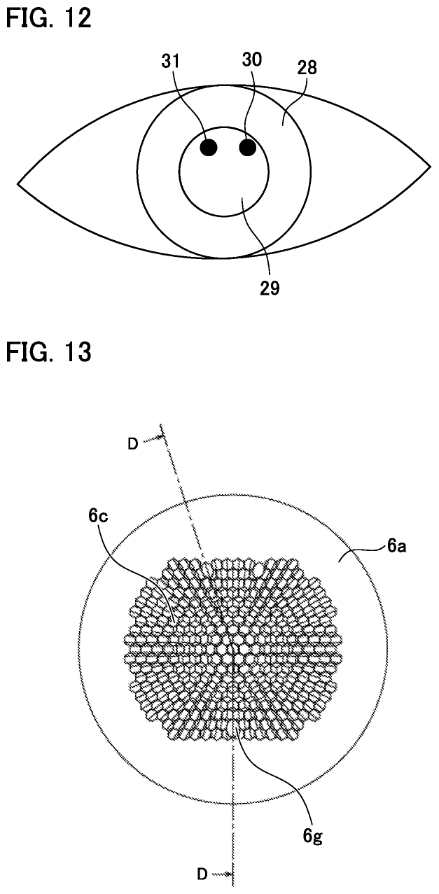

FIG. 12 is a schematic view which describes an eyeball distance between an eyeball image and a corneal reflex image. Corneal reflex images 30 and 31 by an iris 28, a pupil 29, and the infrared LEDs 22 and 23 for illumination are shown, respectively. A direction of the line of sight is detected based on a relationship between a center of the pupil 29 and the corneal reflex image. For the line-of-sight detection, a method of using reflected light obtained when a surface of the eyeball of the observer is illuminated is known. For example, in the line-of-sight correction, line-of-sight input processing is performed after a correction factor for correcting an individual difference of the eyeball of the user is acquired, and an angle of the line-of-sight direction and coordinate values on an observation surface are calculated using an arithmetic expression corresponding to the correction factor. Specifically, since it can be realized by a method disclosed in Patent Literature 2, detailed description thereof will be omitted.

In a configuration in which a direction of the opening portion of the angle selection type transmission element is set to a direction of light directed from a lens to an eye point, it is necessary to take measures against an occurrence of vignetting and the decrease in opening ratio due to a narrow eye box. In addition, it is necessary to take measures to suppress vignetting of infrared LED light directed from the eye point to the line-of-sight detection sensor.

In the present embodiment, the measures can be taken by detecting the line-of-sight direction of the user and using a result of the line-of-sight detection in a finder using the angle selection type transmission element. In addition, it is possible to provide a finder having a line-of-sight detection function that realizes functions such as ranging point selection while reducing ghosts caused by light coming from behind the user.

### Second Embodiment

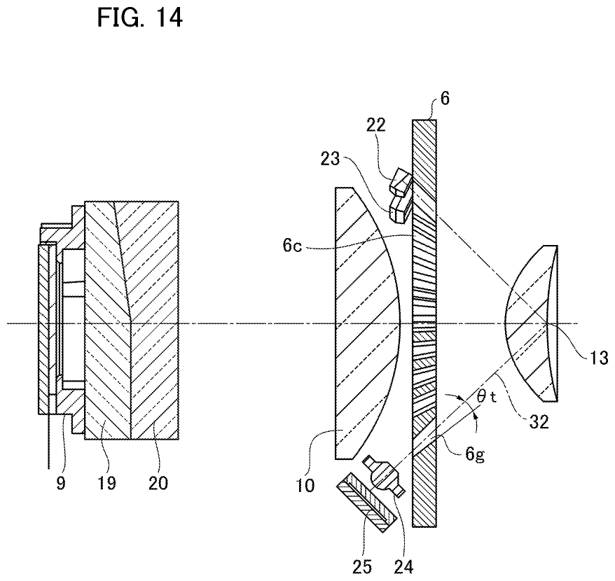

A second embodiment of the present invention will be described with reference to FIGS. 13 and 14. Description of the same items as in the first embodiment will be omitted, and differences from the first embodiment will be described. Such a method of omitting a description will be the same as in embodiments to be described below.

In the present embodiment, an example in which the line-of-sight detection sensor 25 is disposed in the vicinity of the angle selection type transmission element 6 is shown. FIG. 13 is an external view of the angle selection type transmission element 6 of the present embodiment, and shows the first surface 6a side. FIG. 14 is a configuration view using a D-D cross section in FIG. 13.

The line-of-sight detection sensor 25 of the present embodiment is disposed outside the eyepiece lens system 10. The angle selection type transmission element 6 is provided on a front surface side (the eye point 13 side) of the infrared LEDs 22 and 23 and the line-of-sight detection sensor 25. Since it is difficult for sunlight, which is external light, to directly enter the line-of-sight detection sensor 25, an occurrence of erroneous detection can be suppressed.

In FIG. 14, light directed from the eye point 13 to the line-of-sight detection sensor 25 is shown in an optical path 32. A direction of the optical path 32 is not the same as the direction of the opening portion 6c set to the direction of the light directed from the eyepiece lens system 10 to the eye point 13. An opening portion 6g of the angle selection type transmission element 6 through which the light along the optical path 32 passes is formed in a conical shape whose axial center is substantially parallel to the optical path 32 and has a taper angle (refer to θt in FIG. 14) such that vignetting does not occur.

### Third Embodiment

Next, a third embodiment of the present invention will be described. The present embodiment is different from the embodiments described above in that the angle selection type transmission element 6 is formed of an infrared transmissive resin material.

The angle selection type transmission element 6 is formed of a material that transmits infrared light and absorbs visible light. According to the present embodiment, it is possible to suppress intrusion of external light such as sunlight without changing the directions of the opening portions of the angle selection type transmission element 6 according to an optical path directed from the eye point 13 to the line-of-sight detection sensor 25.

According to the embodiment, it is possible to provide an optical device that has a line-of-sight detection function capable of suppressing the vignetting and the decrease in opening ratio by detecting the line-of-sight direction of the user, and realizing functions such as ranging point selection while reducing ghosts caused by light coming from behind the user. Although the preferred embodiments of the present invention have been described above, the present invention is not limited to these embodiments, and various modifications and changes can be made within the scope of the gist thereof

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An optical device including a finder, comprising:
an angle selection type transmission element that is disposed in an optical path of the finder;
a detection unit configured to perform line-of-sight detection by light passing through the angle selection type transmission element; and
a mechanical unit that is capable of adjusting a direction of the finder to a line-of-sight direction detected by the detection unit.

2. The optical device according to claim 1,
wherein the angle selection type transmission element has a plurality of opening portions that limit a passage direction of a light flux.

3. The optical device according to claim 2,
wherein the detection unit has a light projecting unit and a light receiving unit, and
a first opening portion, among the plurality of opening portions, has a first angle that limits the passage direction of the light flux in a first region, a second opening portion has a second angle that limits the passage direction of the light flux in a second region, and a third opening portion has a third angle that is defined by a line connecting an eye point in the finder and the light receiving unit with respect to an optical axis of the finder.

4. The optical device according to claim 3,
wherein the third opening portion has an opening larger than the first or second opening portion.

5. The optical device according to claim 3,
wherein the third opening portion is formed closer to an optical axis side of the finder than the first or second opening portion.

6. The optical device according to claim 3,
wherein a portion in which the third opening portion is formed in the angle selection type transmission element is larger than a thickness of a peripheral portion of the portion.

7. The optical device according to claim 6, further comprising:
an eyepiece lens system,
wherein the portion in which the third opening portion is formed in the angle selection type transmission element is formed along a curved surface facing the eyepiece lens system.

8. The optical device according to claim 3,
wherein the third opening portion is formed at a position farther from the optical axis of the finder than the first or second opening portion.

9. The optical device according to claim 1, further comprising:
a plurality of finders corresponding to both eyes,
wherein the finder is adjustable independently for the detected line-of-sight direction.

10. The optical device according to claim 1,
wherein the angle selection type transmission element is formed of an infrared transmissive material.

11. A display device comprising:
an angle selection type transmission element that is disposed in an optical path of a finder;
a detection unit configured to perform line-of-sight detection with light passing through the angle selection type transmission element; and
a mechanical unit that is capable of adjusting a direction of the finder to the line-of-sight direction detected by the detection unit,
wherein the finder has a display and an eyepiece lens system.

12. The display device according to claim 11, further comprising:
an optical path split prism unit disposed between the display and the eyepiece lens system,
wherein the detection unit detects light that has passed through the optical path split prism unit.

13. The display device according to claim 11,
wherein the detection unit has a light projecting unit and a light receiving unit disposed between the eyepiece lens system and the angle selection type transmission element.
